(19) United States
(12) Patent Application Publication
(10) Pub. No.: US 2010/0157503 A1
(43) Pub. Date: Jun. 24, 2010

(54) Fine Electrode Body, Ion Generator Using Same and Neutralization Apparatus

(76) Inventors: Susumu Saito, Tokyo (JP); Akira Okuyama, Tokyo (JP)

Correspondence Address: Roylance, Abrams, Berdo & Goodman, 1300 19th Street, NW, Suite 600, Washington, DC, 20036, US

(21) Appl. No.: 11/989,533

(22) PCT Filed: Aug. 24, 2006
(86) PCT No.: PCT/JP2006/316580

§ 371 Date: Jan. 28, 2008

(30) Foreign Application Priority Data
Sep. 14, 2005 (JP) 2005 266830

(51) Int. Cl. H01T 23/00; C25B 11/00

(52) U.S. Cl. 361/231; 204/288.1

(57) ABSTRACT

Disclosed is a fine electrode body which is good in ion generation efficiency, maintenancability and handleability, and enables to reduce cost and the required installation space. Also disclosed are an ion generator using such a fine electrode body and a neutralization apparatus. Specifically disclosed is a fine electrode body wherein a discharge electrode, which is composed of a linear conductive member having a plurality of fine projections, and an induction electrode, which is composed of a linear conductive member arranged opposite to the discharge electrode, are arranged on a dielectric body. One or more of such fine electrode bodies are arranged on a sheet-like or film-like supporting body. Also specifically disclosed are an ion generator using such a fine electrode body and a neutralization apparatus.

### BACKGROUND OF THE INVENTION

### Field of the Invention

The present invention relates to a fine electrode body, an ion generator using the same and a neutralization apparatus, more particularly, to a fine electrode body capable of generating ions efficiently and favorable in maintainability and handleability at the time of exchanging and cleaning, and an ion generator using the same and a neutralization apparatus.

### BACKGROUND ART

### Description of the Background Art

Referring to general types of conventional ion generators and neutralization apparatuses, for example, in the case of a conventional neutralization apparatus, a high voltage is applied from a high-voltage power supply to an acuminate needle-like ion generation electrode to generate corona discharge, by which air is ionized. Since the needle-like ion generation electrode requires an efficient corona discharge between itself and an opposing ground electrode, it is necessary to keep a certain insulation distance. As a result, a space for effecting ion generation has restrictions, thus there has been a problem that efficient downsizing of ion generators and neutralization apparatuses is limited.

Further, there has been a tendency that, due to prolonged use, a needle-like ion generation electrode has difficulty generating corona discharge by accumulation of dust or influence of abrasion due to physical sputtering to decrease the ion generation efficiency. Still further, for a ground electrode opposite to the needle-like ion generation electrode and installed for stabilizing discharge, dust or the like is accumulated to advance contamination on the surface by electrostatic absorption due to high voltage and physical sputtering of ion generation electrode, thereby causing a reduction in ion generation efficiency.

Therefore, a user is required to regularly perform maintenance work for cleaning or exchanging an acuminate part of the needle-like ion generation electrode and also cleaning a ground electrode and the vicinity thereof to improve the ion generation efficiency. Since the maintenance work includes cleaning of the interior of a structure having an acuminate part or a high-voltage applied part, the work is dangerous and also very troublesome.

Then, a plate-like ion generation element has been developed in which a discharge electrode and an induction electrode are arranged on a plate-like dielectric body in place of the needle-shaped ion generation electrode (refer to Patent Documents 1 to 3).

According to the technologies disclosed in Patent Documents 1 to 3, the plate-like ion generation element is formed in a flat shape free from a physical acuminate structure, because a high-voltage power supply is applied to locally discharge between the discharge electrode and the induction electrode via a dielectric body to generate ions. Further, since a local discharge is used, it is possible to generate ions in a quantity equal to that of the needle-like ion generation electrode at a lower voltage and a lower consumption of electricity. Further, an insulation protection layer as a coating layer is formed on the discharge electrode, by which it is possible not only to prevent deterioration of electrodes and current leakage to the surface but also to improve maintainability. As a result, a problem of the needle-like ion generation electrode is reduced.

However, the ion generation electrode in an electrode structure formed via the above-mentioned dielectric body becomes unable to generate ions since impedance between the electrodes is increased to reduce efficiency unless a relative high-frequency electricity is supplied.

Then, for example, where a high-frequency high-voltage power supply is applied in a constitution in which positive ions and negative ions are alternately generated periodically from one ion generation element by application of an AC power supply, positive ions and negative ions are generated at very short intervals. Therefore, the generated ions are neutralized with reverse polarity ions generated by a next period and made electrically stable, by which ions become extremely difficult to emit, as a result, a problem is imposed that the ion generation efficiency is reduced as a whole.

Further, where a high-voltage power supply (such as a pulse wave) having a direct-current component including a high-frequency component the ion concentration of which can be easily adjusted is applied, positive ions generated by application of a high voltage power having a current component of a positive polarity emit due to Coulomb's force in a wider area than that of a case of application of the above-mentioned high frequency high voltage power to enable prevention of neutralization. However, since ions having only either one polarity are generated, in the case of an ion generator or neutralization apparatus requiring bipolar ions, at least one more apparatus or two apparatuses in total are required, whereby advantages cannot be expected in terms of cost and space saving.

Still further, where bipolar ions are required, for example, at least two ion generation elements are used to generate positive ions and negative ions, however, scattering in ion generation capability may occur according to the installation position relationship between each ion generation element. In other words, where a distance between the respective ion generation elements is relatively short, generated ions are neutralized to decrease the ion generation efficiency as a whole. Where a distance between the ion generation elements is long, a site at which ions are spatially localized is generated. For this reason, in the commercialization of products different in usage and size, optimal conditions must be derived in consideration of a difference in performance depending on the installation position of an ion generation element. Thus, there is a great effect on cost in view of product development.

In addition, for reasons of space saving, it is possible to make two ion generation elements into one package to apply a direct-current high-voltage power supply of each polarity. However, a positive-ion generating discharge electrode is spatially close to a negative-ion generating discharge electrode, thereby neutralization due to mixture of positive ions with negative ions is increased, thereby ion generation efficiency as a whole is reduced. Further, since the thus constituted ion generation element is similar in price to the manufacturing of two elements, no cost advantage is expected.

In order to solve the above-described conventional problems, the present inventor has previously proposed an ion generation element, which is provided with a dielectric body having at least two faces, at least two discharge electrodes arranged at least on the two faces of the dielectric body, and an induction electrode arranged inside the dielectric body and subjected to actions of at least the two discharge electrodes, as well as an ion generator using the ion generation element and a neutralization apparatus (Japanese Published Unexamined Patent Application No. 2005-043456).

The previously proposed technology is not only able to generate both positive and negative ions using a single ion generation element but also high in ion generation efficiency, less variation in generation performance, and stable in generating ions, and allows for cost reduction and space saving. Further, an ion generator equipped with an ion generation element is able to easily deliver the thus generated ions by arranging the ion generation element under an environment of air current.

The present inventor has also proposed an ion generation element constituted in a plug and socket form so as to be attachable and detachable to improve maintainability at the time of exchange and cleaning, an ion generator using the ion generation element and a neutralization apparatus (Japanese Published Unexamined Patent Application No. 2005-043488).
Patent Document 1: Japan Patent Pre-Publication No. 2003-323964
Patent Document 2: Japan Patent Pre-Publication No. 2003-249327
Patent Document 2: Japan Patent Pre-Publication
Patent Document 3: Japan Patent Pre-Publication No. 2004-105517

### SUMMARY OF THE INVENTION

The present inventor, due to the need for generating ions more efficiently and improving maintainability and handleability exchanging and cleaning, has continued to study the previously proposed technology.

Therefore, an object of the present invention is to provide a fine electrode body favorable in ion generation efficiency, maintainability and handleability and capable of reducing cost and the required installation space, and an ion generator using the fine electrode body and a neutralization apparatus.

The present invention for solving the above object includes the following constitution:

[1] A fine electrode body, including a discharge electrode constituted by using a linear conductive member having a plurality of fine projections and an induction electrode constituted by using a linear conductive member opposite to the discharge electrode which are arranged on a dielectric body, wherein

one or more of the fine electrode bodies are arranged on a sheet-like or film-like supporting body.

[2] the fine electrode body according to the above [1], wherein

two or more of the fine electrode bodies are consecutively installed on the sheet-like or film-like supporting body.

[3] The fine electrode body according to the above [1] or [2], wherein

the sheet-like or film-like supporting body acts as the dielectric body as well.

[4] the fine electrode body as set forth in any one of the above [1] to [3], wherein the sheet-like or film-like supporting body is flexible.

[5] The fine electrode body as set forth in any one of the above [1] to [4], wherein

the sheet-like or film-like supporting body is a long body.

[6] The fine electrode body according to the above [5], wherein

the fine electrode body is arranged in parallel to the longitudinal direction of the long body.

[7] The fine electrode body according to the above [5], wherein

the fine electrode body is arranged in parallel to the width direction of the long body.

[8] The fine electrode body as set forth in any one of the above [5] to [7], wherein

an electrode contact of the fine electrode body is installed at the end of the long body in the width direction or in the vicinity of the end thereof.

[9] The fine electrode body as set forth in any one of the above [5] to [8], wherein the sheet-like or film-like supporting body is formed so as to be folded like bellows having any given folding width and at least one of the fine electrode bodies is arranged at each of the folded parts.

[10] The fine electrode body as set forth in any one of the above [5] to [8], wherein

the sheet-like or film-like supporting body is constituted so as to be formed in an annular shape in which both ends of the long body are connected to each other.

[11] The fine electrode body as set forth in any one of the above [1] to [8], wherein

the sheet-like or film-like supporting body is formed so as to be wound in a roll shape.

[12] The fine electrode body as set forth in any one of the above [1] to [11], wherein

a separation and cut-off line is formed at any given position between the fine electrode bodies on the sheet-like or film-like supporting body.

[13] The fine electrode body as set forth in any one of the above [1] to [12], wherein

at least one of the discharge electrode, the induction electrode and the electrode contact is formed by the printing method or the inkjet method.

[14] An ion generator, wherein the fine electrode body described in any one of the above [1] to [13] is arranged to apply a driving voltage between the discharge electrode and the induction electrode of the fine electrode body, and the discharge caused by the potential difference is used to generate ions from the dielectric body.

[15] The ion generator according to the above [14], wherein the fine electrode body is attached in a removable manner.

[16] The ion generator according to the above [14], wherein a voltage is applied partially to two or more of the fine electrode bodies installed consecutively to generate ions, and a fine electrode, which generates ions by voltage application, is exchanged every predetermined time or every time of reduction in ion generation efficiency.

[17] The ion generator according to the above [14], wherein a voltage is applied partially to two or more of the fine electrodes installed consecutively to generate ions, and a fine electrode, which generates ions by voltage application, is rotated every predetermined time.

[18] The ion generator as set forth in any one of the above [14] to [17], wherein an air current delivery means is provided for delivering generated ions by air current and the fine electrode body is arranged under the air current environment by the air current delivery means.

[19]A neutralization apparatus, wherein the ion generator as set forth in any one of the above [14] to [18] is used to effect neutralization.

According to the above [1] of the invention, such a fine electrode body can be obtained that is favorable in ion generation efficiency, maintainability and handleability and also allows for cost reduction and space saving.

In particular, a fine electrode body having a linear discharge electrode and an induction electrode is formed in a sheet-like or film-like supporting body, thereby giving a flat shape free from a physical acuminate structure. As a result, where an ionized product is allowed to be in contact, the fine electrode body will not be caught by the ionized product or damage it, thus obtaining a higher degree of freedom in designing the position at which the fine electrode body is arranged, the means for installing it and the like.

Further, since a fine electrode is constituted by using a linear discharge electrode having a plurality of fine projections and a linear induction electrode, it is able to generate ions efficiently, thereby contributing to reductions in electricity consumption and cost. Further, since the fine electrode body is arranged on a sheet-like or film-like supporting body, it not only contributes to space saving but also secures maintainability and handleability at the time of cleaning and exchanging due to a decrease in ion generation efficiency or expiration of the life-span.

According to the above [2] of the invention, two or more of the fine electrode bodies are installed consecutively, by which such a case can be handled that bipolar ions are required and at least two fine electrode bodies are also required.

According to the above [3] of the invention, the sheet-like or film-like supporting body is constituted so as to act as the dielectric body as well, thus making it possible to reduce cost and space.

According to the above [4] of the invention, the sheet-like or film-like supporting body is constituted so as to be flexible, which is favorable in handleability and can be used uninhibitedly on assembly of the supporting body into an ion generator, a neutralization apparatus and the like, thus giving a higher adaptability and versatility and also contributing to space saving.

According to the above [5] to [7] of the invention, the sheet-like or film-like supporting body is constituted so as to be a long body, thus making it possible to install many fine electrode bodies consecutively. Further, the supporting body can be accommodated in a state that it is wound when it is not used or a part thereof is not used.

According to the above [8] of the invention, the fine electrode body is constituted so that each of the electrode contacts is installed at the end of the long body in the width direction or in the vicinity of the end thereof, thus making it possible to apply voltage to the fine electrode body communicatively connected to the electrode contact via connection to each of the electrode contacts.

According to the above [9] of the invention, the sheet-like or film-like supporting body is formed so as to be folded like bellows having any given folding width, and at least one of the fine electrode bodies is arranged at each of the folded parts, thus making it possible to install many fine electrode bodies consecutively. Further, the supporting body can be accommodated in a state that it is folded when it is not used or a part thereof is not used.

According to the above [10] of the invention, the sheet-like or film-like supporting body is constituted so as to be formed in an annular shape in which both ends of the long body are connected to each other, thus making it possible to obtain an annularly arranged fine electrode body without any need for fixing a plurality of electrode bodies annularly via other members such as fixing members.

According to the above [11] of the invention, the sheet-like or film-like supporting body is formed so as to be wound in a roll shape, by which it can be accommodated in a state that it is wound when it is not used or a part thereof is not used.

According to the above [12] of the invention, a separation and cut-off line is formed at any given position between the fine electrode bodies of the sheet-like or film-like supporting body, thereby making it is possible to cut off a necessary quantity (number) of fine electrode bodies for use.

According to the above [13] of the invention, at least one of a discharge electrode, an induction electrode and an electrode contact, preferably all of them are formed by a printing method or an inkjet method, thereby they can be not only quite easily formed as compared with the conventional installation of needle-like electrodes but also formed in a flat shape, which is free from any trouble-causing projections on the surface or any physical acuminate structure.

According to the above [14] of the invention, the fine electrode body of any one of the first to thirteenth aspects of the invention is arranged to apply a driving voltage between a discharge electrode and an induction electrode of the fine electrode body and the discharge caused by the potential difference is used to generate ions from the dielectric body, thus making it possible to generate ions efficiently.

According to the above [15] of the invention, the fine electrode body is constituted so as to be attached in a removable manner, by which it can be quite easily attached or detached at the time of maintenance such as for exchanging and cleaning.

According to the above [16] of the invention, a voltage is partially applied to two or more of the fine electrode bodies installed consecutively to generate ions, and a fine electrode, which generates ions by voltage application, is exchanged every predetermined time or every time of reduction in ion generation efficiency, thereby a new fine electrode body excellent in ion generation efficiency can always be used to generate ions efficiently.

According to the above [17] of the invention, a voltage is partially applied to two or more of the fine electrodes installed consecutively to generate ions, and a fine electrode, which generates ions by voltage application, is rotated every predetermined time, thus making it possible to extend the maintenance period.

According to the above [18] of the invention, provided is an air-current delivery means for delivering generated ions by air current, and the fine electrode body is arranged under air current by the air current delivery means, thus making it possible to deliver the thus generated ions more efficiently.

According to the above [19] of the invention, the ion generator of any one of the fourteenth to eighteenth aspects of the invention is used to effect neutralization, thereby providing a neutralization apparatus which is favorable in ion generation efficiency, maintainability and handleability and also allows for cost reduction and space saving.

### BRIEF DESCRIPTION OF THE DRAWINGS

FIG. 1 is a partial perspective view showing one embodiment of the fine electrode body of the present invention.

FIG. 2 is a partial perspective view showing another embodiment of the fine electrode body of the present invention.

FIG. 3 is a partial perspective view showing another embodiment of the fine electrode body of the present invention.

FIG. 4 is a partial perspective view showing another embodiment of the fine electrode body of the present invention.

FIG. 5 is a perspective view showing another embodiment of the fine electrode body of the present invention.

FIG. 6 is a partial perspective view showing another embodiment of the fine electrode body of the present invention.

FIG. 7 is a perspective view showing another embodiment of the fine electrode body of the present invention.

FIG. 8 is a perspective view showing another embodiment of the fine electrode body of the present invention.

FIG. 9 are perspective views showing other embodiments of the fine electrode body of the present invention.

FIG. 10 are perspective views of other embodiments of the fine electrode body of the present invention.

FIG. 11 is a partial perspective view showing another embodiment of the fine electrode body of the present invention.

FIG. 12 is a partial perspective view showing still another embodiment of the fine electrode body of the present invention.

FIG. 13 is a partial perspective view showing still another embodiment of the fine electrode body of the present invention.

FIG. 14 is a partial perspective view showing still another embodiment of the fine electrode body of the present invention.

FIG. 15 is a partial perspective view showing still another embodiment of the fine electrode body of the present invention.

FIG. 16 is a partial perspective view showing still another embodiment of the fine electrode body of the present invention.

FIG. 17 is a perspective view showing one embodiment of the neutralization apparatus of the present invention.

FIG. 18 is a cross sectional view of FIG. 17.

FIG. 19 is a cross sectional view showing another embodiment of the neutralization apparatus of the present invention.

FIG. 20 is a perspective view showing one example of the fine electrode body used in the neutralization apparatus shown in FIG. 19.

FIG. 21 is a perspective view showing another embodiment of the neutralization apparatus of the present invention.

FIG. 22 is a cross sectional view explaining the other embodiment of the neutralization apparatus of the present invention.

### DETAILED DESCRIPTION OF THE PREFERRED EMBODIMENTS

Hereinafter, a description is given of the details of the fine electrode body of the present invention with reference to the attached drawings.

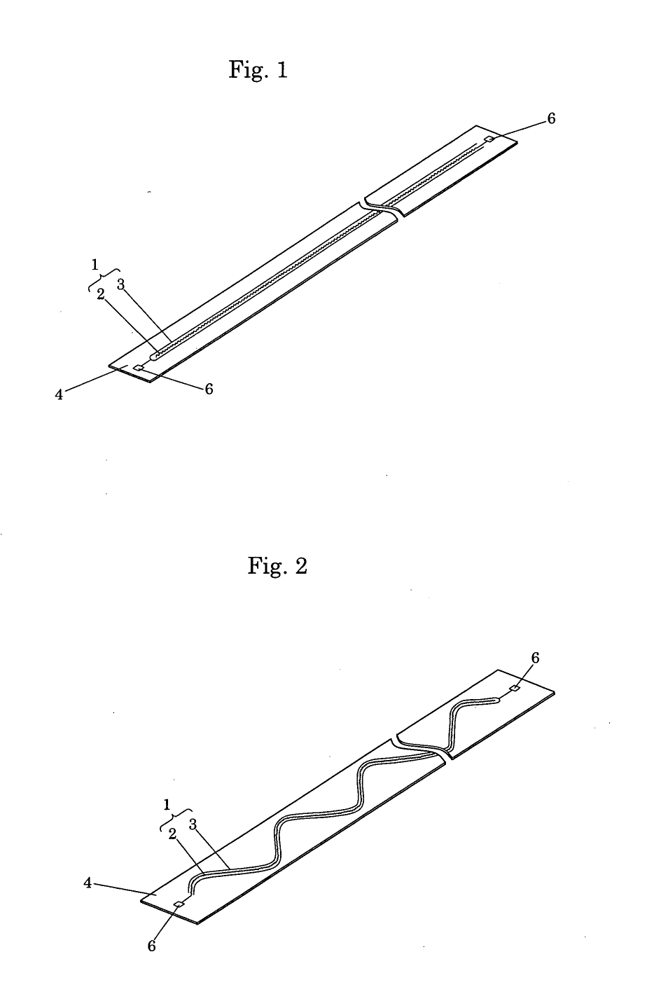

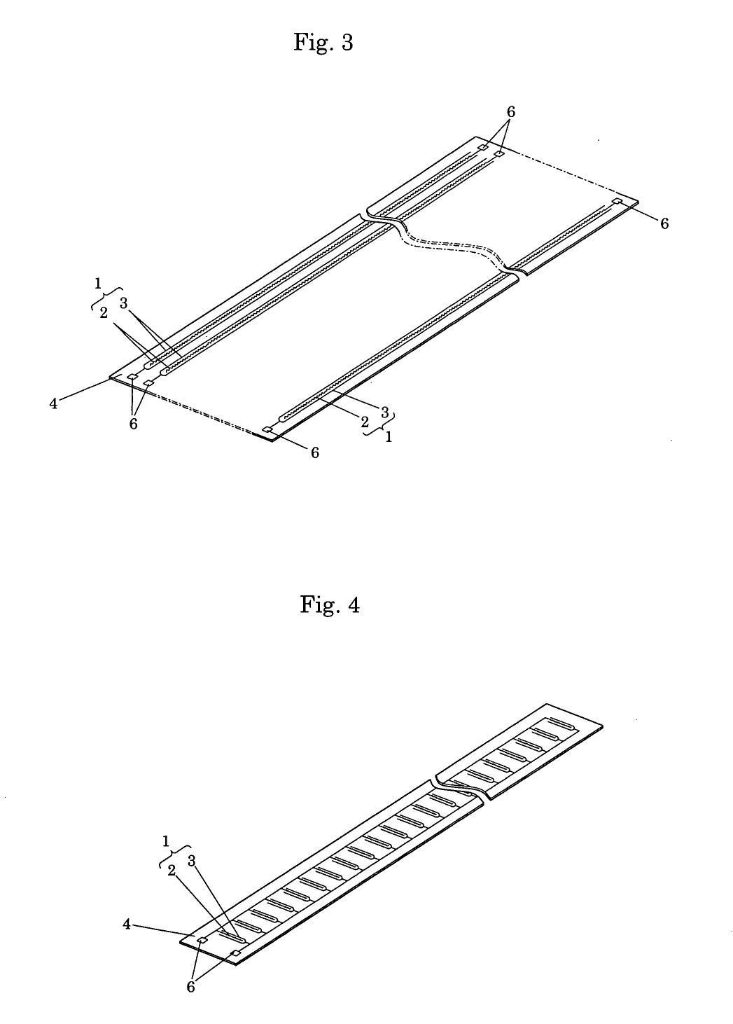

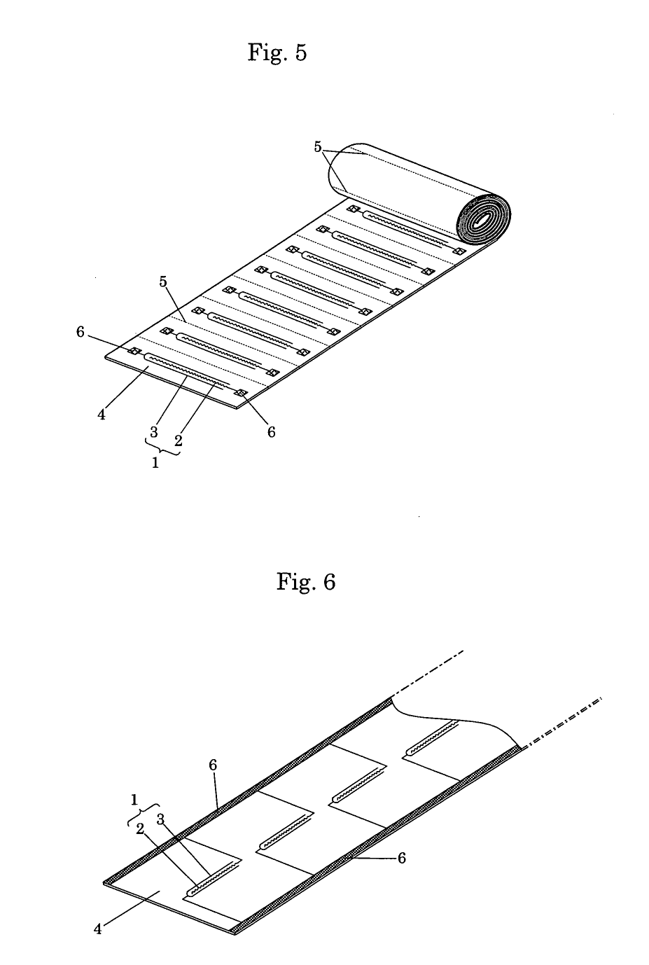

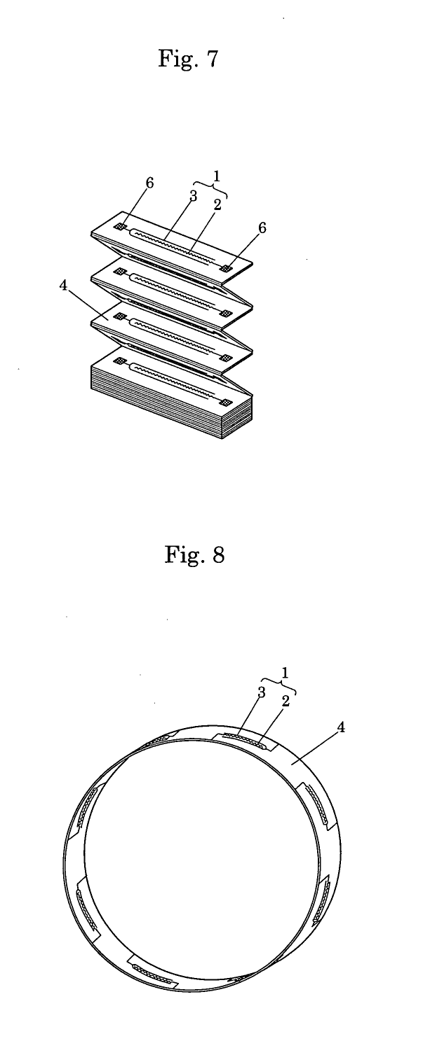

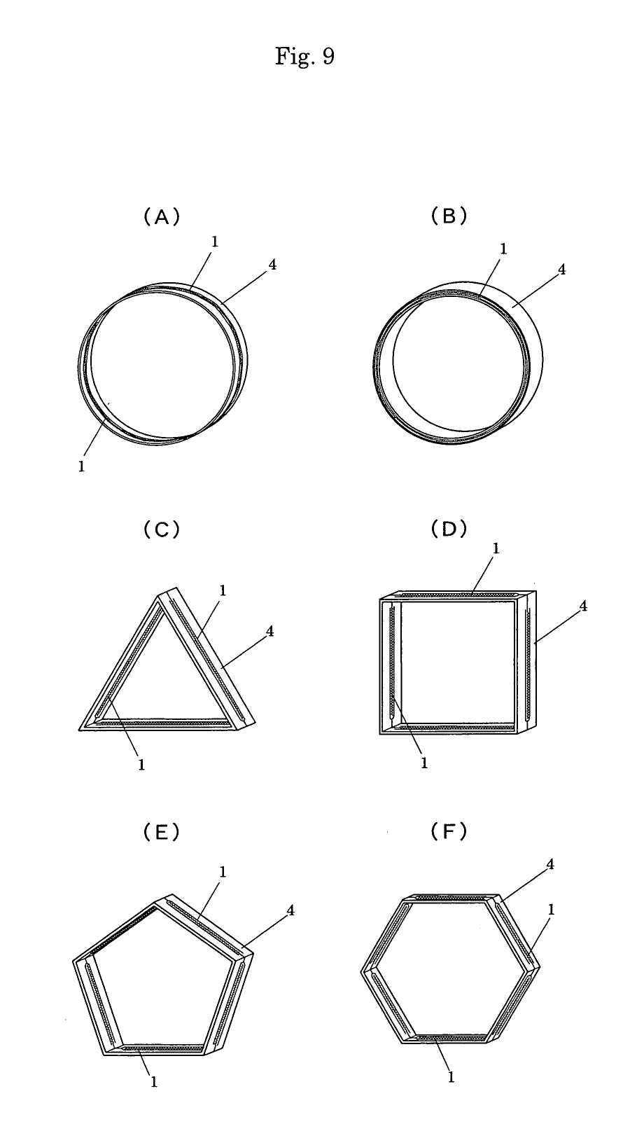

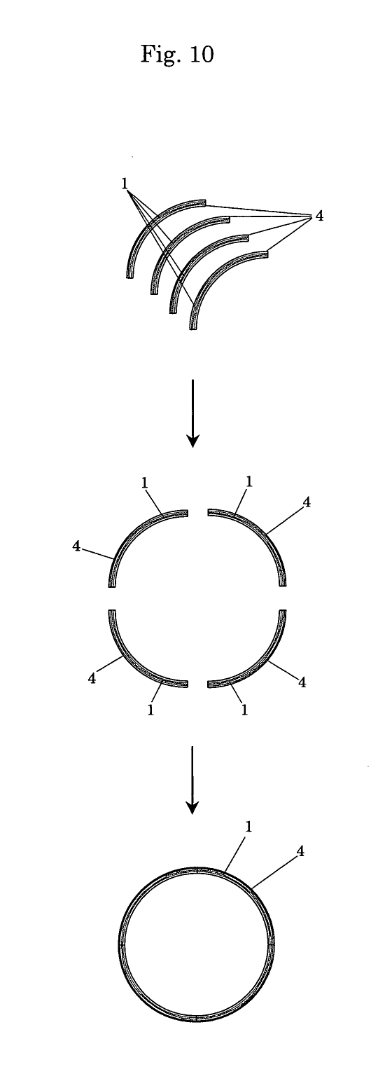

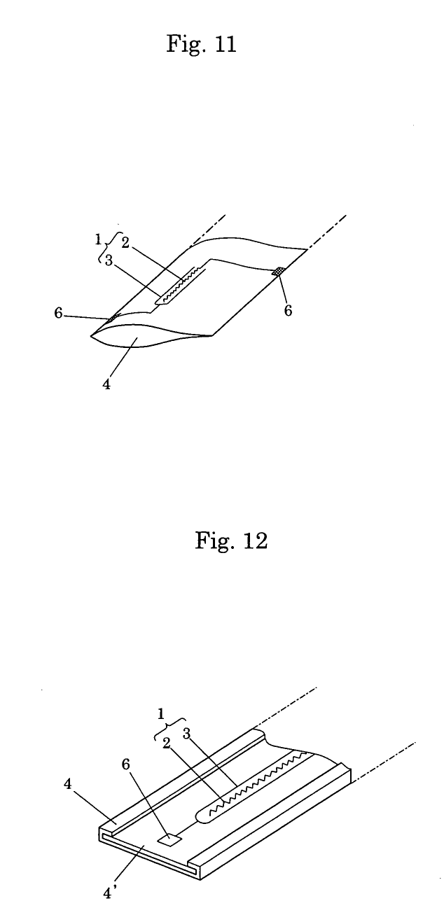

FIG. 1 is a partial perspective view showing one embodiment of the fine electrode body of the present invention. FIG. 2, FIG. 3, FIG. 4, FIG. 6 and FIG. 11 are partial perspective views showing other embodiments of the fine electrode body of the present invention. FIG. 5, FIG. 7, FIG. 8 and FIG. 9 (A) to (F) are perspective views showing other embodiments of the fine electrode body of the present invention. FIG. 10 is a perspective view showing the other embodiment of the fine electrode body of the present invention. FIG. 12 to FIG. 16 are partial perspective views showing still other embodiments of the fine electrode body of the present invention.

As shown in FIG. 1 to FIG. 11, the fine electrode body 1 of the present invention is provided with a discharge electrode 2 constituted by a linear conductive member having a plurality of fine projections and an induction electrode 3 constituted by a linear conductive member opposite to the discharge electrode 2 on a dielectric body, and one or more of the thus constituted fine electrode bodies 1 are arranged on a sheet-like or film-like supporting body 4. In addition, in the aspects shown in FIG. 1 to FIG. 11, the sheet-like or film-like supporting body 4 is constituted so as to act as a dielectric body as well.

The following is a description for each of the aspects shown in FIG. 1 to FIG. 11.

FIG. 1 shows an aspect in which one long fine electrode body 1 is arranged in parallel to a long sheet-like or film-like supporting body 4 in the longitudinal direction of the long supporting body. FIG. 2 shows an aspect in which a meandering long fine electrode body 1 is arranged on a long sheet-like or film-like supporting body 4. FIG. 3 shows an aspect in which two or more of long fine electrode bodies 1 are consecutively arranged. FIG. 4 shows an aspect in which two or more of the fine electrode bodies 1 are consecutively arranged in parallel to a long sheet-like or film-like supporting body 4 in the width direction of the long body. FIG. 5 shows an aspect in which two or more of the fine electrode bodies 1 are consecutively arranged in parallel to a long sheet-like or film-like supporting body 4, which is also in a roll shape so as to wind in the width direction of the long body. FIG. 6 shows an aspect in which two or more of the fine electrode bodies 1 are arranged straightly in parallel to a long sheet-like or film-like supporting body 4 in the longitudinal direction of the long body. FIG. 7 shows an aspect in which at least one of the fine electrode bodies 1 is arranged at each of the bellow-like folded parts on a long bellow-like sheet-like or film-like supporting body 4 foldable at any given folding width. FIG. 8 shows an aspect in which a long sheet-like or film-like supporting body 4 is connected at the both ends thereof to form an annular shape and at least two or more of the fine electrode bodies 1 are arranged respectively on the inner face and the outer face of the annular shape.

Moreover, where a sheet-like or film-like supporting body 4 is made long, the length is, for example, 3 cm to 30 cm. Where the supporting body is made long to be about 30 cm, it is longer than the longer side of A4-size sheet (or a shorter side of A3-size sheet). Thus, it can be used as an electrifier for a copying machine, a neutralization apparatus and the like. Also, as the aspects shown in FIG. 5 and FIG. 7, the sheet-like or film-like supporting body 4 is formed in a roll shape or a bellow shape, thereby it can be accommodated in a state that it is folded when it is not used or a non-use part thereof is folded.

Further, FIG. 9 shows other embodiments in which, as with FIG. 8, a long sheet-like or film-like supporting body 4 is connected at the both ends to form an annular shape. More specifically, in the drawing, (A) shows an aspect in which one long fine electrode body 1 is arranged respectively on the annular inner face and outer face of the circular shape shown in FIG. 8; (B) shows an aspect in which the long fine electrode body 1 is arranged circularly at the annular end face portion of the circular shape shown in FIG. 8; (C) shows an aspect in which the sheet-like or film-like supporting body 4 is formed in a triangular annular shape and the fine electrode body 1 is arranged on the inner face and the outer face at each side of the triangular shape; (D) shows an aspect in which the sheet-like or film-like supporting body 4 is formed in a rectangular annular shape and the fine electrode body 1 is arranged on the inner face and the outer face at each side of the rectangular shape; (E) shows an aspect in which the sheet-like or film-like supporting body 4 is formed in a pentagonal annular shape and the fine electrode body 1 is arranged on the inner face and the outer face at each side of the pentagonal shape; and (F) shows an aspect in which the sheet-like or film-like supporting body 4 is formed in a hexagonal annular shape and the fine electrode body 1 is arranged on the inner face and the outer face at each side of the hexagonal shape.

Still further, FIG. 10 shows an aspect in which a plurality of sheet-like or film-like supporting bodies 4 (four supporting bodies in this aspect) are formed in a divided state, and these divided pieces are jointed together to form a supporting body 4. In this aspect, the fine electrode body 1 may be arranged on each of the divided pieces before joining or may be arranged on the supporting body 4 after joining. In addition, in the aspect shown in FIG. 10, the sheet-like or film-like supporting body 4 is formed in a circular annular shape. The present invention shall not be limited thereto and includes other shapes shown in FIG. 9 (C) to (F) or may also include other constitutions in terms of the number of divisions and divided shapes.

In addition, FIG. 11 shows an aspect in which the sheet-like or film-like supporting body 4 is provided with a streamlined cross section. The sheet-like or film-like supporting body 4 with the streamlined cross section is more effective when used in a neutralization apparatus having an air current delivery means to be described later.

Moreover, the sheet-like or film-like supporting body 4 is not limited to a long body and may include planar single shapes like polygonal and circular shapes such as a rectangular shape, a square shape or other shapes and shapes adjusted to an apparatus or a part to be adopted (for example, a crank shape and a curved shape).

The sheet-like or film-like supporting body 4 is constituted by a thin plate body such as glass, a resin sheet or a film, preferably a flexible synthetic resin sheet or film. Synthetic resins used as the sheet or the film include, for example, polyethylene terephthalate (PET), polyethylene napthalate (PEN), polyether sulphone (PES), polyether imide, polyether ether ketone, polyfenylene sulfide, polyarylate, polyimide, polycarbonate (PC), triacetate cellulose (TAC) and cellulose acetate propionate (CAP). In addition, where a material devoid of flexibility is used, such a supporting body may be used that is flexible in structure (the invention described in claim 7, for example).

An arrangement example in which one or two or more of fine electrode bodies 1 are installed consecutively on the sheet-like or film-like supporting body 4 includes that in which, as shown in FIG. 4, FIG. 5 and FIG. 7, fine electrode bodies 1, 1 . . . may be arranged in parallel to the width direction of a long body, that in which, as shown in FIG. 1, FIG. 3, FIG. 6, FIG. 8, FIG. 9, FIG. 10 and FIG. 11, fine electrode bodies 1, 1 . . . may be arranged in parallel to the longitudinal direction of the long body or arranged obliquely, and that in which, as shown in FIG. 2, fine electrode bodies 1, 1 . . . may be arranged in a meandering manner. Further, a face on which the sheet-like or film-like supporting body 4 is arranged is not limited to one of the faces and may include an example where two or more of consecutively installed fine electrode bodies 1•1 . . . may be arranged on both of the faces or may be arranged at the end face part. It is preferable that they are arranged on both the faces when using a DC power supply and on either of the faces when using an AC power supply.

As shown in FIG. 5, it is preferable that a separation and cut-off line 5 is formed between the fine electrode bodies 1 on the sheet-like or film-like supporting body 4. The separation and cut-off line 5 is preferably constituted so as to be easily cut off manually such as a perforated part or a thinly formed part. It is also acceptable that a position which can be cut off is only indicated like that of a severable position depicted with a line. Further, the separation and cut-off line 5 can be positioned between individual spaces formed by adjacent fine electrode bodies 1, 1, by which the fine electrode body 1 can be separated one by one. Alternatively, two or more of the separation and cut-off lines 5 are provided every given plurality of units, by which the fine electrode bodies 1, 1 . . . can be separated every two or more of any given plurality of units. The separation and cut-off line 5 is provided, thereby making it possible to separate a necessary quantity (number) of fine electrode bodies 1 and for use.

Next, a description is given for a discharge electrode 2, an induction electrode 3 and a dielectric body which constitute the fine electrode body 1 arranged on the sheet-like or film-like supporting body 4.

There is no particular restriction on the material of the discharge electrode 2 used in the fine electrode body 1 of the present invention as long as it is electrically conductive, including, for example, titanium, stainless steel, tungsten and electric conductive ceramics. The discharge electrode 2 is preferably made of the material resistant to deterioration due to discharge or to fusion. Depending on a material and the use application of the discharge electrode 2, an insulation protection layer treated by surface coating is formed so as to cover the discharge electrode 2, by which not only can the discharge electrode 2 be increased in life but also dust generation resulting from the discharge electrode 2 can be reduced to simplify the maintenance work. The surface coating material includes a DLC (diamond like carbon) thin film coating and an epoxy insulating material.

The discharge electrode 2 is preferably formed in a linear shape having a plurality of fine projections. The fine projections are preferably in a range of 0.01 mm to 10 mm. There is no particular restriction on the shape of the projections as long as they are shaped so as to generate ions, including, for example, such shapes as those shown in the prior arts (Japanese Patent Application No. 2005-043456 and Japanese Patent Application No. 2005-043488) and other shapes such as a wave, circle and lattice. The ion generation efficiency is found to be influenced most by a distance between the opposite induction electrode 3 and fine projections of the discharge electrode 2 and the shape of these projections, rather than the shape of the discharge electrode 2. In addition, there is no particular restriction on the shape as long as it is able to easily and efficiently attain electric field concentration.

The induction electrode 3 used in the fine electrode body 1 of the present invention is formed so as to enclose the discharge electrode 2. A distance between the discharge electrode 2 and the induction electrode 3 formed so as to enclose the discharge electrode is preferably in a range of 0.01 mm to 5 mm. Further, there is no particular restriction on the shape thereof, including a plate-like shape, circular shape, columnar shape and cylindrical shape. The induction electrode 2 may be made of a dielectric material such as alumina, glass and mica.

The dielectric body used in the fine electrode body 1 of the present invention is made of a dielectric material such as alumina, glass and mica. As described previously, in the aspects shown in FIG. 1 to FIG. 11, the sheet-like or film-like supporting body 4 is constituted so as to act as the dielectric body as well. In addition as shown in FIG. 12 to FIG. 16 to be described later, the present invention also includes an aspect in which the dielectric body is separated from the sheet-like or film-like supporting body 4.

The discharge electrode 2 and the induction electrode 3 apply driving voltage via electrode contacts 6•6 installed at the end of the sheet-like or film-like supporting body 4 or in the vicinity of the end thereof, thereby generating ions. There is no particular restriction on a power supply of the driving voltage, including those used in publicly known ion generators or neutralization apparatuses.

As shown in FIG. 1, FIG. 2, FIG. 3, FIG. 5, FIG. 7 and FIG. 11, the electrode contact 6 may be installed at each of the fine electrode bodies 1. Alternatively, as shown in FIG. 4 and FIG. 6, it may be installed every two or more of the fine electrode bodies 1, 1 . . . , which are kept connected. Further, where the separation and cut-off line 5 is installed or in some other cases, the electrode contact 6 is preferably installed every range divided by the separation and cut-off lines 5•5.

There is no particular restriction on the material of the electrode contact 6 of the discharge electrode 2 and of the induction electrode 3, and any publicly known material may be used as an electrode contact.

The electrode contact 4, discharge electrode 2, and induction electrode 3 may be formed by any publicly known methods such as etching, electric discharge machining, cutting, and laser machining. In the present invention, these are preferably formed by using the printing method or inkjet method.

The printing method includes offset printing, silk screen printing, relief printing, screen printing, planographic printing, intaglio printing, and screen printing.

Further, the inkjet method includes publicly known methods, for example, on-demand types such as the piezoelectric method and bubble jet (registered trade mark) method or continuous ejection types such as the electrostatic attraction method.

Where the printing method or the inkjet method is adopted, it is preferable that the discharge electrode 2, the induction electrode 3 and the electrode contact 4 are formed by using a fluid material containing metal fine particles and electric-conductive polymers. The discharge electrode 2, the induction electrode 3 and the electrode contact 4 formed on the flexible supporting body are improved in durability, thereby providing a fine electrode body excellent in performance.

In the thus constituted fine electrode body 1 of the present invention, a driving voltage is applied between the discharge electrode 2 and the induction electrode 3, and positive ions and/or negative ions are generated by the discharge resulting from the potential difference. In an aspect in which fine electrode bodies 1, 1 . . . are arranged on both faces of the sheet-like or film-like supporting body 4, ions can be generated on both faces of the sheet-like or film-like supporting body 4. In this instance, positive ions are generated on one of the faces, while negative ions are generated on the other face, by which positive ions and negative ions are generated in a state of being separated spatially by the sheet-like or film-like supporting body 4 in itself. As a result, the neutralization (offset) is decreased to further increase the ion generation efficiency. In addition, in this instance, the positive ions and the negative ions are always generated at a constant positional relationship, resulting in a constant capacity of generating ions, by which there is a lower difference in ion generating capacity due to the interference influence by the respective polarities of the fine electrode bodies 1, 1.

Moreover, there may be such a problem in an ion generation system using voltage application type corona discharge that increases ion concentration also results in an increase in ozone concentration. This problem is not an exceptional case for the fine electrode body 1 of the present invention. However, it is known that increases in ozone concentration can be prevented by preventing the concentration of the electrical field between the faces via actions of the discharge electrode 2 and the induction electrode 3 to suppress the current value between the electrodes (decrease in capacitive coupling between the electrodes).

In the above-described aspects in FIG. 1 to FIG. 11, the sheet-like or film-like supporting body 4 is constituted so as to act as a dielectric body as well. However, the present invention shall not be limited thereto and can be constituted by a separate body as shown in FIG. 12 to FIG. 16.

FIG. 12 shows a constitution in which the sheet-like or film-like supporting body 4 is arranged so as to hold both ends of a dielectric body 4′ in the width direction. The supporting body 4 is preferably made of a flexible substrate such as polyimide, silicon resin and polypropylene resin.

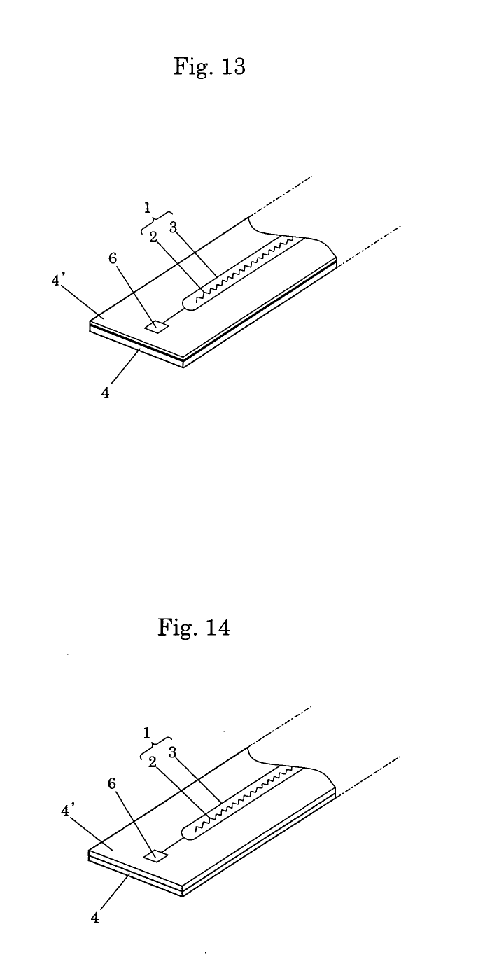

FIG. 13 shows a constitution in which the sheet-like or film-like supporting body 4 is laminated on the lower layer of the dielectric body 4′ by adhesive or other methods. The supporting body 4 is formed of the same materials as those shown in FIG. 12. Alternatively, double-face tape, a rubber magnet, a sheet fastener and the like are used as the supporting body 4, thus making it possible to easily attach the supporting body to an ionized product, a neutralization apparatus, an ion generator and the like.

FIG. 14 shows a constitution in which the sheet-like or film-like supporting body 4 made of a material similar to that of the dielectric body 4′ is laminated on the lower layer of the dielectric body 4 by a laminating method such as an adhesive.

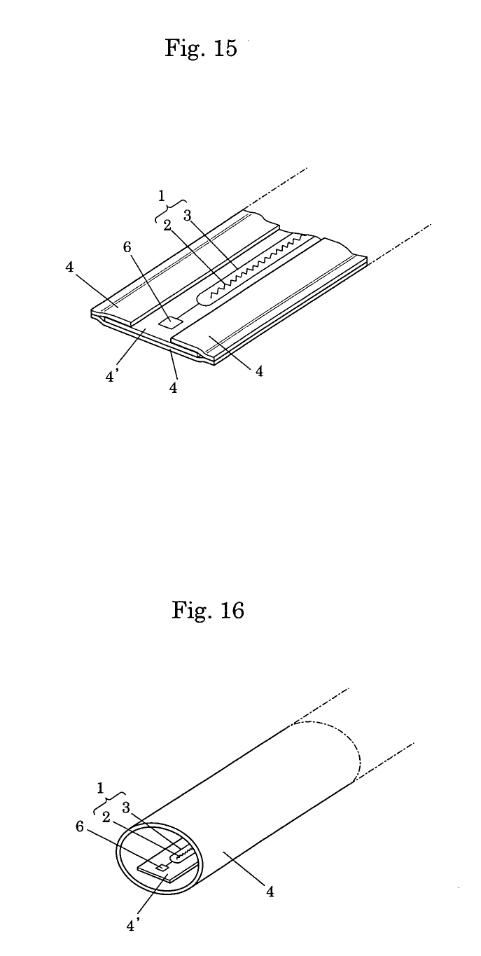

FIG. 15 shows a constitution in which a plurality of the sheet-like or film-like supporting bodies 4 are attached between both faces of the dielectric body 4′. The supporting body 4 is formed of a material similar to that shown in FIG. 12.

FIG. 16 shows a constitution in which the sheet-like or film-like supporting body 4 is formed in a cylindrical tubular shape and the fine electrode body 1 having the dielectric body 4′ is arranged inside the cylindrical tube. The supporting body 4 is formed of a material similar to that shown in FIG. 12. Further, according to this aspect, an air current delivery means such as a fan or compressed air is used to pass on air current inside the cylindrical tube, thus making it possible to deliver ions generated by the fine electrode body 1.

Next, a description is given for an ion generator of the present invention.

The ion generator of the present invention is constituted in such a manner that a driving voltage is applied between the discharge electrode 2 and the induction electrode 3 of the above-described fine electrode body 1, thereby generating ions by the discharge resulting from the potential difference. Where the ion generator of the present invention is used, for example, as an electrifier/neutralization apparatus of a copying machine, it can be used in a simpler constitution than that in which a conventional needle-like discharge electrode is used, thereby facilitating improvements in various points such as ion generation efficiency, maintenacability and safety. In particular, in an ion generator using needle-like discharge electrodes, ionization must be performed in a non-contact state so as not to damage an ionized product. However, the ion generator of the present invention is capable of more efficient ionization, without posing any problems in contact therewith, due to the absence of needle-like projections.

An ion generator used where there is a distance to an ionized product is preferably provided with an air current delivery means for delivering generated ions by air current (for example, an air blasting means like a fan). Further, the ion generator having the air current delivery means is preferably provided with a fine electrode body 1 under the air current environment by an air current delivery means. In an aspect where arranged are two or more of fine electrode bodies 1, 1 . . . consecutively installed on both faces of the sheet-like or film-like supporting body 4, the fine electrode body 1 is preferably arranged along the air current direction in such a manner that the both faces are provided under the air current environment in equal proportion and the both surfaces are allocated to respective sides directly in the air current direction. With the above constitution, positive ions and negative ions are generated being separated spatially, under a state where the neutralization (offset) is decreased to keep a desired ion generation efficiency, by the allocated air current, the positive ions and negative ions are delivered, thereby attaining a high ion delivery efficiency.

The ion generator is also preferably provided with an ion-concentration adjusting means for changing the ion quantity of at least either of the positive ions or negative ions.

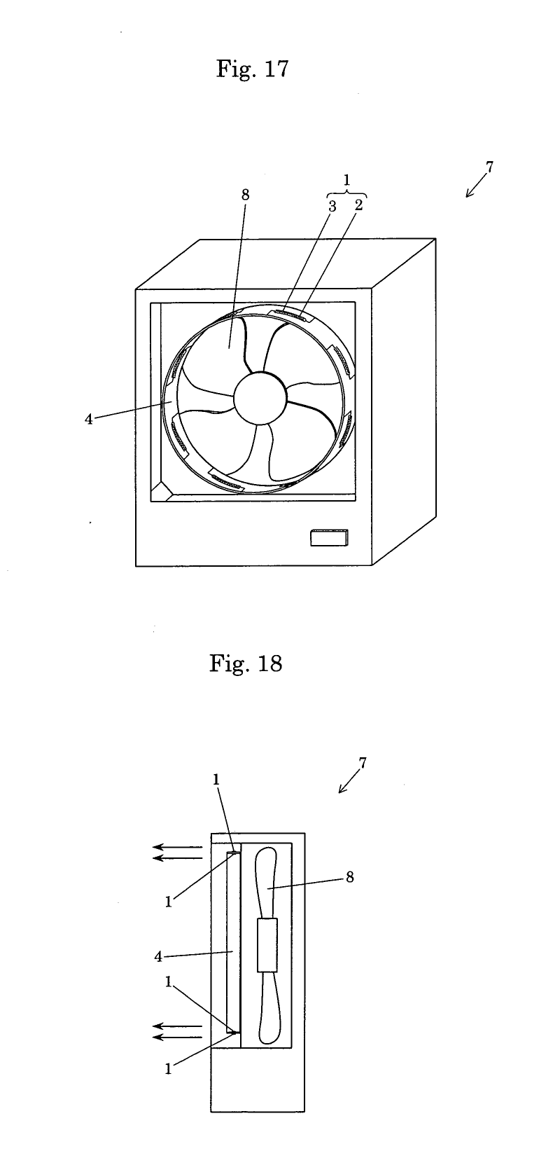

Next, a description is given of the neutralization apparatus of the present invention in which an ion generator having the air current delivery means is used to effect neutralization, among the above-described ion generators with reference to FIG. 17 to FIG. 22. Regarding a specific constitution of the above ion generator, refer to the description for the neutralization apparatus described below.

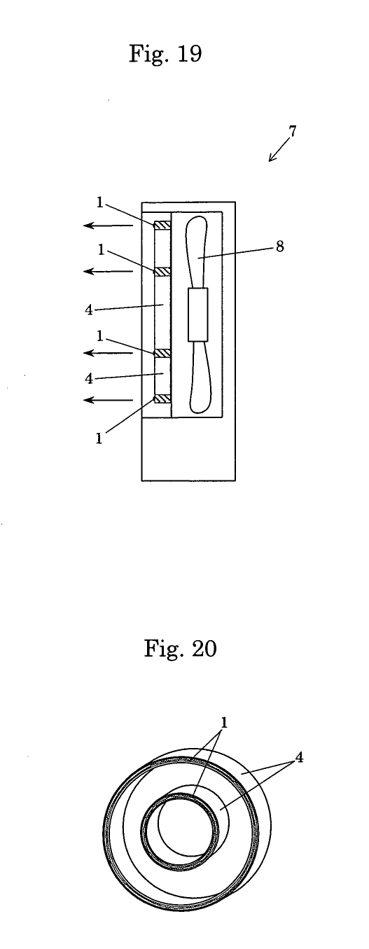

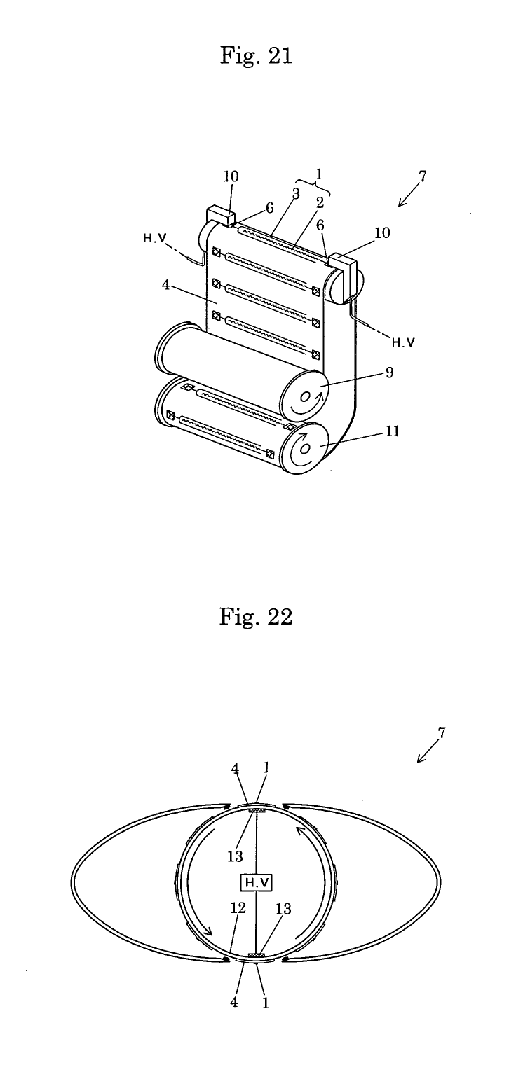

FIG. 17 is a perspective view showing one embodiment of the neutralization apparatus of the present invention. FIG. 18 is a cross sectional view of FIG. 17. FIG. 19 is a cross sectional view showing the other embodiment of the neutralization apparatus of the present invention. FIG. 20 is a perspective view showing one example of the fine electrode body used in the neutralization apparatus shown in FIG. 19. FIG. 21 is a perspective view showing another embodiment of the neutralization apparatus of the present invention. FIG. 22 is a cross sectional view for showing another embodiment of the neutralization apparatus of the present invention.

The neutralization apparatus 7 shown in FIG. 17 and FIG. 18 is an apparatus which is provided with the ion generator of the present invention capable of generating ions by the fine electrode body 1 of the present invention, thereby effecting the neutralization by the thus generated ions.

The neutralization apparatus 7 is provided with a fine electrode body 1 and a propeller fan 8, or a delivery means for delivering ions generated by the fine electrode body 1. In addition, a power supply part is not illustrated. Further, the neutralization apparatus 7 is preferably provided with an adjustment means for adjusting the ion balance and ion concentration.

The size of the neutralization apparatus 7, the shape thereof, the number of fine electrode bodies 1 to be arranged, and delivery performance of the propeller fan 8 will be established appropriately depending on applications such as intended use and installation place. The neutralization apparatus 7 shown in FIG. 17 and FIG. 18 is classified as a fan-type neutralization apparatus in which the propeller fan 8 is used as an ion delivery means.

The present embodiment is constituted in such a manner that the fine electrode body 1 is arranged on both faces of the sheet-like or film-like supporting body 4 formed annularly similar to the annular fine electrode body 1 shown in FIG. 8, which is installed under the air current environment by a propeller fan 11, with the delivery of air current kept. The fine electrode body 1 is attached to the neutralization apparatus 7 in a removable manner and can be detached at the time of maintenance such as for exchanging or cleaning thereof.

Further, the neutralization apparatus 7 shown in FIG. 19 is an apparatus in which, in place of the annular fine electrode body 1 of the neutralization apparatus 7 shown in FIG. 17 and FIG. 18, a double annular fine electrode body 1•1 shown in FIG. 20 is used to effect neutralization. It is the same neutralization apparatus as that of the neutralization apparatus 7 shown in FIG. 17 and FIG. 18 except for the fine electrode bodies 1, 1.

The fine electrode bodies 1•1 shown in FIG. 20 are those in which small and large annular sheets different in diameter or film-like supporting bodies 4•4 are used and the fine electrode bodies 1•1 are arranged on the end face of the annular sheet. They are constituted in such a manner that the fine electrode bodies 1•1 are arranged all over the surface of the neutralization apparatus 7.

According to the present embodiment, since the fine electrode bodies 1•1 are arranged on the front face, dust and the like can be very easily wiped away at the time of maintenance. Further, each of the fine electrode bodies 1•1 can be insulated to a great extent, thus making it possible to generate ions more efficiently. In addition, a backlight and the like are arranged on the neutralization apparatus 7, by which the presence of the fine electrode bodies 1•1 arranged on the front face can be made conspicuous.

Further, the neutralization apparatus 7 shown in FIG. 21 in which the roll-like fine electrode body 1 shown in FIG. 5 is used is constituted in such a manner that the fine electrode body 1 wound around a reeling-out means 9 is reeled out, and some of the plurality of fine electrode bodies 1 consecutively installed on the sheet-like or film-like supporting body 4 (one in the present embodiment) are applied with a voltage via a conducting contact 10 to generate ions and rolled up by a rolling-up means 11 every predetermined time or every decrease in ion generation efficiency, by which the ion-generating fine electrode body 1 is exchanged. In other words, voltage is constantly applied to a new (or cleaned) fine electrode body 1 to generate ions efficiently, and when the fine electrode body 1 is to be maintained (cleaned or exchanged), it is exchanged with another new (or cleaned) fine electrode body 1, and this procedure is repeated, thus making it possible to retain a favorable generation of ions until all the roll-like fine electrode bodies 1 are used up.

Still further, the neutralization apparatus 7 shown in FIG. 22 is constituted in such a manner that the fine electrode body 1 is arrayed on one face, or an outer peripheral face of the sheet-like or film-like supporting body 4 formed annularly as with the annular fine electrode body 1 shown in FIG. 8 and an electrode contact 6 is installed on the inner peripheral face, which is wound around an annular electrode drum body 12 and subjected to voltage application via a conducting contact 13 installed on the inner peripheral face of the electrode drum 12, thereby generating ions. The electrode drum 12 is rotated at any given angle every predetermined time, thereby rotating a plurality (eight in the present embodiment) of fine electrode bodies 1 sequentially. In other words, ion-generating fine electrode bodies 1 are rotated every predetermined time, by which voltage is applied sequentially to a new (or cleaned) fine electrode body 1, thus making it possible to generate ions constantly and efficiently. Such a constitution is added that the surface of the fine electrode 1 which has generated ions over a predetermined time is wiped by a cleaning means 14 such as a brush when or after the electrode drum 12 is rotated, thus making it possible to extend the maintenance period.

It is preferable that fine electrode bodies 1 used in the neutralization apparatus 7 of the present invention adopt a cassette type or a unit type so that they can be easily attached or detached for exchanging.

In the above-described neutralization apparatus 7 of the present invention, as a method for adjusting ion balance (ion concentration), a control method for controlling ON and OFF of an output voltage is preferably adopted, however, the ion balance may be adjusted by other control methods such as output current control, bias control of power supply and bias control of induction electrode. Further, in an application that ion balance accuracy is required, it is preferable to adopt a method for securing the accuracy by sensing an ion generating state.

A fine electrode body 1 used in the neutralization apparatus 7 of the present invention can be driven at a lower voltage to reduce danger, thus making it possible to adopt such a constitution that the fine electrode body 1 is exposed to the front face or surface side of the neutralization apparatus 7. By adopting a constitution that the fine electrode body 1 is exposed, it is possible to not only easily exchange or clean at the time of maintenance but also the ion generation efficiency can be improved because of a reduction in the number of constitutional members blocking generated ions.

### INDUSTRIAL APPLICABILITY

A fine electrode body, an ion generator using the fine electrode body and a neutralization apparatus of the present invention are capable of generating ions efficiently and can be used as a fine electrode body excellent in maintainability and handleability for exchanging and cleaning, an ion generator using the fine electrode body and a neutralization apparatus.

1. A fine electrode body, including a discharge electrode constituted by using a linear conductive member having a plurality of fine projections and an induction electrode constituted by using a linear conductive member opposite to the discharge electrode are arranged on a dielectric body, and one or more of the fine electrode bodies which are arranged on a sheet-like or film-like supporting body, wherein
two or more of the fine electrode bodies are installed consecutively on the sheet-like or film-like supporting body, the sheet-like or film-like supporting body acts as the dielectric body as well and is a flexible long body, and an electrode contact of the fine electrode body is installed at the end of the long body or in the vicinity of the end thereof in the width direction or in the longitudinal direction and also at each of the fine electrode bodies 1.

2. (canceled)

3. (canceled)

4. (canceled)

5. (canceled)

6. The fine electrode body according to claim 1, wherein
the fine electrode body is arranged in parallel to the longitudinal direction of the long body.

7. The fine electrode body according to claim 1, wherein
the fine electrode body is arranged in parallel to the width direction of the long body.

8. (canceled)

9. The fine electrode body as set forth in claim 1, wherein
the sheet-like or film-like supporting body is formed so as to be folded like bellows having any given folding width and at least one of the fine electrode bodies is arranged at each of the folded parts.

10. The fine electrode body as set forth in claim 1, wherein
the sheet-like or film-like supporting body is constituted so as to be formed in an annular shape in which both ends of the long body are connected to each other.

11. The fine electrode body as set forth in claim 1, wherein
the sheet-like or film-like supporting body is formed so as to be wound in a roll shape.

12. The fine electrode body as set forth in claim 1, wherein
separation and cut-off line is formed at any given position between the fine electrode bodies on the sheet-like or film-like supporting body.

13. The fine electrode body as set forth in claim 1, wherein
at least one of the discharge electrode, the induction electrode and the electrode contact is formed by the printing method or the inkjet method.

14. An ion generator, wherein
the fine electrode body described in claim 1 is arranged to apply a driving voltage between the discharge electrode and the induction electrode of the fine electrode body, and the discharge caused by the potential difference is used to generate ions from the dielectric body.

15. The ion generator according to claim 14, wherein
the fine electrode body is attached in a removable manner.

16. The ion generator according to claim 14, wherein
a voltage is applied partially to two or more of the fine electrode bodies installed consecutively to generate ions, and a fine electrode, which generates ions by voltage application, is exchanged every predetermined time or every time of reduction in ion generation efficiency.

17. The ion generator according to claim 14, wherein
a voltage is applied partially to two or more of the fine electrodes installed consecutively to generate ions, and a fine electrode, which generates ions by voltage application, is rotated every predetermined time.

18. The ion generator as set forth in claim 14, wherein
an air current delivery means is provided for delivering generated ions by air current and the fine electrode body is arranged under the air current environment by the air current delivery means.

19. A neutralization apparatus, wherein
the ion generator as set forth in claim 14 is used to effect neutralization.
